(19) United States
(12) Patent Application Publication
(10) Pub. No.: US 2016/0308315 A1
(43) Pub. Date: Oct. 20, 2016

(54) Electrical Connecting Module and Electrical Connecting Assembly for a Jacket of a Handheld Electronic Device

(71) Applicant: Sunonwealth Electric Machine Industry Co., Ltd., Kaohsiung City (TW)

(72) Inventors: Alex Horng, Kaohsiung City (TW); Chun Ko, Kaohsiung City (TW); Ching-Ting Pien, Kaohsiung City (TW)

(21) Appl. No.: 15/088,233

(22) Filed: Apr. 1, 2016

(30) Foreign Application Priority Data
Apr. 15, 2015 (TW) 104112083

(51) Int. Cl. H01R 24/64; H01R 27/02

(52) U.S. Cl. CPC H01R 24/64; H01R 27/02; H01R 2107/00

(57) ABSTRACT

The present invention discloses an electrical connecting module for a jacket of a handheld electronic device, in which the electrical connecting module can be integrated with another component to form a single electrical connecting assembly for powering the jacket while allowing data transmission or charging operation of the handheld electronic device. The electrical connecting module for the jacket of the handheld electronic device includes a body and a conducting wire. The body includes a retaining hole and a plurality of electrical contacts. The retaining hole is adapted for partially receiving a connecting plug of a transmission line. The plurality of electrical contacts is located at an end of the body. The conducting wire is electrically connected to the plurality of electrical contacts. The present invention further discloses an electrical connecting assembly.

### CROSS REFERENCE TO RELATED APPLICATIONS

The application claims the benefit of Taiwan application serial No. 104112083, filed on Apr. 15, 2015, and the subject matter of which is incorporated herein by reference.

### BACKGROUND OF THE INVENTION

1. Field of the Invention

The present invention generally relates to an electrical connecting module and an electrical connecting assembly and, more particularly, to an electrical connecting module for a jacket of a handheld electronic device and an electrical connecting assembly for the jacket and the handheld electronic device.

2. Description of the Related Art

With the continuous improvement of semiconductor technology, new kinds of handheld electronic devices, such as handheld computers, handheld game consoles, mobile phones, e-book readers, smart phones, tablets or phablets, are put into the consumer market rapidly and frequently. By the digital content installed inside, these handheld electronic devices can provide various functions such as communication, document processing and entertainment.

Due to the increased functions of such a handheld electronic device, the handheld electronic device is often used for a longer duration of time, leading to the development of a variety of jackets of the handheld electronic device, such as the one with a cooling function which allows the heat of the handheld electronic device to be properly dissipated during the use of said device (such as during the game play). Such a jacket can be seen in China Patent No. 204028752U.

When a conventional jacket with a cooling function is in use, a fan inside the jacket requires DC power for operations. Although the DC power can be provided through a transmission port and a transmission cable (such as micro USB or Lightening USB) of the handheld electronic device, the handheld electronic device is often designed with a single transmission port in order to reduce the volume of said device. However, the single transmission port can only be used for data transmission purposes or charging purposes at the same time. In words, when the transmission port of the handheld electronic device is used to power the jacket, data cannot be transmitted through the transmission port at the same time, and the original charging function of said device is affected. To solve the problem, different cables may be used where one of which is used to power the jacket and the other one is used to provide data transmission function or charging function of the handheld electronic device. However, the use of multiple cables and the difference in the lengths of the cables may cause troubles to the user. Therefore, it is necessary to provide a solution for powering the jacket while providing data transmission function or charging function of the handheld electronic device.

### SUMMARY OF THE INVENTION

It is therefore the objective of this invention to provide an electrical connecting module for a jacket of a handheld electronic device, in which the electrical connecting module can be integrated with another component to form a single electrical connecting assembly for powering the jacket while allowing data transmission or charging operation of the handheld electronic device.

It is another objective of this invention to provide an electrical connecting assembly capable of powering the jacket while providing data transmission function or charging function of the handheld electronic device.

The present invention provides an electrical connecting module for a jacket of a handheld electronic device comprising a body and a conducting wire. The body includes a retaining hole and a plurality of electrical contacts. The retaining hole is adapted to partially receive a connecting plug of a transmission line, and the plurality of electrical contacts is located at an end of the body. The conducting wire electrically connected to the plurality of electrical contacts.

In a form shown, the connecting plug and the plurality of electrical contacts are located at the end of the body when the connecting plug is partially received in the retaining hole.

In the form shown, the plurality of electrical contacts is located at two opposite sides of the retaining hole.

In the form shown, the body further includes two opposite end faces, and the retaining hole extends through the two end faces.

In the form shown, the body further includes a lateral surface arranged between the two end faces. A breaking portion is formed on the lateral surface and extends through the two end faces, and the breaking portion further extends from the lateral surface to an inner periphery of the body defining the retaining hole.

In another form shown, the body further includes a top surface arranged between the two end faces. A receiving channel is formed on the top surface and extends through the two end faces, and the receiving channel further extends from the top surface to an inner periphery of the body defining the retaining hole.

In the other form shown, the body further includes a dust cover adapted to close the receiving channel.

In the other form shown, the dust cover has one end that is connected to the body in a bendable manner.

In the form shown, the body further includes a top surface arranged between the two end faces, and a through-hole is formed on the top surface and communicates with the retaining hole.

In the form shown, the through-hole is filled with gel to adhere the body and the connecting plug to each other.

In the form shown, the through-hole is in a form of a countersink adapted to be screwed by a screw in order for the body and the connecting plug to be engaged to each other.

In the form shown, the body and the connecting plug are enveloped together by a covering material.

In the form shown, the covering material is a thermoplastic sleeve, a resin sleeve or a silicone sleeve.

In the form shown, the covering material is a shell.

In the form shown, the connecting plug is fixed in the retaining hole of the body in a press fit manner.

In the form shown, a positioning portion is formed on an inner periphery of the body defining the retaining hole.

In the form shown, the positioning portion is a shoulder.

In the form shown, the body further includes a connecting port electrically connected to the conducting wire.

In the form shown, a fixing portion is arranged on an outer surface of the conducting wire.

In the form shown, the fixing portion is a groove.

In the form shown, the fixing portion includes an opening facing in a width direction of the body.

In a third form shown, the fixing portion is a fastener having a tongue and a groove respectively arranged at two ends thereof.

In the third form shown, the fixing portion is in a form of at least one hook.

In the third form shown, the at least one hook includes a plurality of hooks, and adjacent two of the plurality of hooks are arranged in opposite directions.

In the form shown, the conducting wire includes one end connected to the body and another end connected with a connector.

In the form shown, the connector is a USB connector.

In the form shown, the conducting wire includes a conducting port adjacent and electrically connected to the connector.

In the form shown, the connector is electrically connected to a converter.

In the form shown, the transmission line includes a USB plug. The USB plug and the connector are electrically connected to a splitter.

The present invention further provides an electrical connecting assembly comprising a transmission line and an electrical connecting module. The transmission line includes a connecting plug. The electrical connecting module includes a body and a conducing wire. The body includes a retaining hole and a plurality of electrical contacts. The connecting plug is partially received in the retaining hole. The plurality of electrical contacts is located at an end of the body and electrically connected to the conducting wire. The conducting wire and the transmission line are combined as a conducting cable.

In a form shown, the conducting wire and the transmission line are integrally formed as the conducting cable.

In the form shown, the conducting cable is made by wrapping the conducting wire and the transmission line with a covering material.

In the form shown, the connecting plug and the plurality of electrical contacts are located at the end of the body when the connecting plug is partially received in the retaining hole.

In the form shown, the plurality of electrical contacts is located at two opposite sides of the retaining hole.

In the form shown, the body further includes two end faces, and the retaining hole extends through the two end faces.

In the form shown, the connecting plug is fixed in the retaining hole in a press fit manner.

In the form shown, a positioning portion is formed on an inner periphery of the body defining the retaining hole and is adapted to abut with the connecting plug.

In the form shown, the positioning portion is a shoulder.

In the form shown, the conducting cable includes one end connected to the body and another end forming an electrical plug, and the electrical plug is electrically connected to the conducting wire and the transmission line.

In the form shown, the body includes a first case and a second case.

In the form shown, a first engaging portion is formed on an end face of the body. A second engaging portion is formed on the conducting cable and is adapted to be engaged with the first engaging portion.

In the form shown, the first engaging portion is an arcuate edge defining an opening, and the second engaging portion is a groove adapted to be engaged with the arcuate edge of the opening.

As a conclusion, the body of the electrical connecting module or the electrical connecting assembly includes the retaining hole and the plurality of electrical contacts. The connecting plug is partially received in the retaining hole of the body so that the connecting plug of the transmission line and the plurality of electrical contacts are located at the same end of the body. The conducting wire is electrically connected with the plurality of electrical contacts. As such, a power source may be electrically connected to the plurality of electrical contacts via the conducting wire to supply power to an electronic element in the jacket such as the fan. Meanwhile, the charging operation and data transmission of the handheld electronic device can be performed via the transmission line. Therefore, power can be supplied to the jacket while data transmission or charging operation of the electronic device can be performed using a single electrical connecting assembly (such as the electrical connecting assembly or the electrical connecting module in combination with the transmission line). Advantageously, the jacket can still be powered without affecting the original charging and data transmission functions of the handheld device. Furthermore, it is not needed to use multiple cables, thereby providing a better user experience of the handheld electronic device.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a perspective view of a transmission cable and an electrical connecting module for a jacket of a handheld electronic device according to a first embodiment of the present invention.

FIG. 2 is a perspective view illustrating an electrical connecting module for a jacket of a handheld electronic device according to a second embodiment of the present invention.

FIG. 3a is a cross sectional view of a fastener of the electrical connecting module in a disengaged state according to the second embodiment of the present invention.

FIG. 3b is a cross sectional view of the fastener of the electrical connecting module in an engaged state according to the second embodiment of the present invention.

FIG. 4 is a perspective view illustrating an electrical connecting module for a jacket of a handheld electronic device in combination with a transmission line according to a third embodiment of the present invention.

FIG. 5 is a perspective view illustrating an electrical connecting module for a jacket of a handheld electronic device in combination with a transmission line according to a fourth embodiment of the present invention.

FIG. 6 is a perspective view illustrating an electrical connecting module for a jacket of a handheld electronic device in combination with a transmission line according to a fifth embodiment of the present invention.

FIG. 7 illustrates the use of the electrical connecting module in combination with the transmission line according to the first embodiment of the present invention.

FIG. 8 is a perspective view of an electrical connecting assembly according to a sixth embodiment of the present invention.

FIG. 9 is an exploded view of an electrical connecting assembly according to a seventh embodiment of the present invention.

FIG. 10 is a perspective view of the electrical connecting assembly according to the seventh embodiment of the present invention.

In the various figures of the drawings, the same numerals designate the same or similar parts. Furthermore, when the terms “first”, “second”, “third”, “fourth”, “inner”, “outer”, “top”, “bottom”, “front”, “rear” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

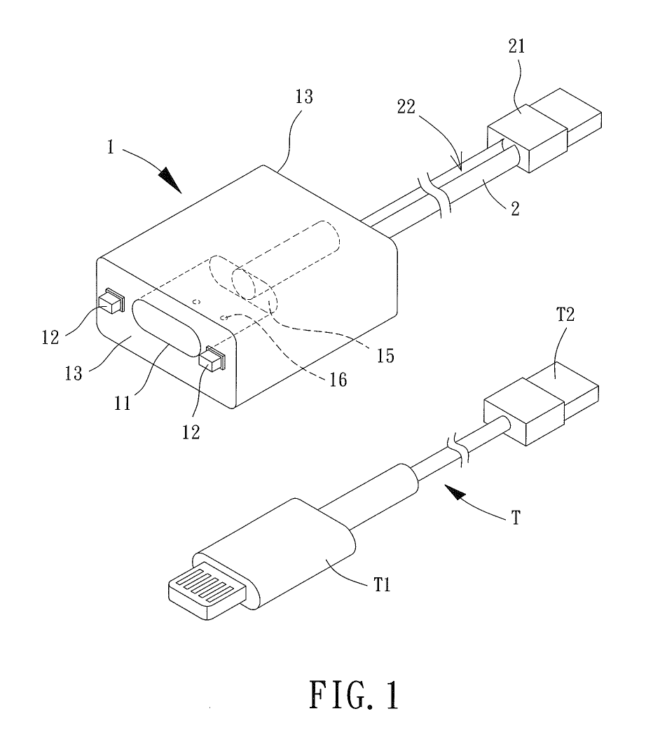

The term “transmission line” used hereinafter in the present invention refers to a transmission medium that can connect to a transmission port of a handheld electronic device in order to supply the power to or provide data transmission function for said device, such as a micro USB to USB cable or a lightning USB cable. As shown in FIG. 1, the transmission line “T” includes one end forming a connecting plug T1 for the handheld device and another end forming a USB plug T2. Each of the connecting plug T1 and the USB plug T2 includes a plurality of conductive terminals, which can be appreciated by the persons ordinarily skilled in the art.

Please refer to FIG. 1, an electrical connecting module for a jacket of a handheld electronic device according to a first embodiment of the present invention includes a body 1 and a conducting wire 2. The body 1 can be made of a flexible, insulating material such as plastic or resin. The body 1 may include a retaining hole 11 and a plurality of electrical contact 12. The retaining hole 11 is adapted to partially receive the connecting plug T1 of the transmission line “T.” The plurality of electrical contact 12 may be located at an end of the body 1, and the conducting wire 2 is electrically connected to the plurality of electrical contact 12. As an example, the conducting wire 2 may be directly connected to the plurality of electrical contact 12 or coupled to the electrical contact 12 via a conducting path.

In this embodiment, the body 1 shown in FIG. 1 may include front and rear surfaces 13 spaced from each other along a length direction, top and bottom surfaces spaced from each other along a height direction perpendicular to the length direction, and two lateral surfaces spaced from each other along a width direction perpendicular to the length and height directions. However, the length, height and width directions may not be perpendicular to each other. The retaining hole 13 extends through the front and rear surfaces 13. The plurality of electrical contact 12 may be located at two opposite sides of the retaining hole 11 respectively adjacent to the two lateral surfaces, but is not limited thereto. One end of the conducting wire 2 is connected to the body 1, and another end of the conducting wire 2 is connected to a connector 21, such as a USB connector. A fixing portion 22 (such as a groove) is formed on an outer surface of the conducting wire 2 for receiving the transmission line “T,” thus preventing damage to the transmission line T resulting from frequent bending of said line “T.” Therefore, the transmission line T and the conducting wire 2 can be assembled together.

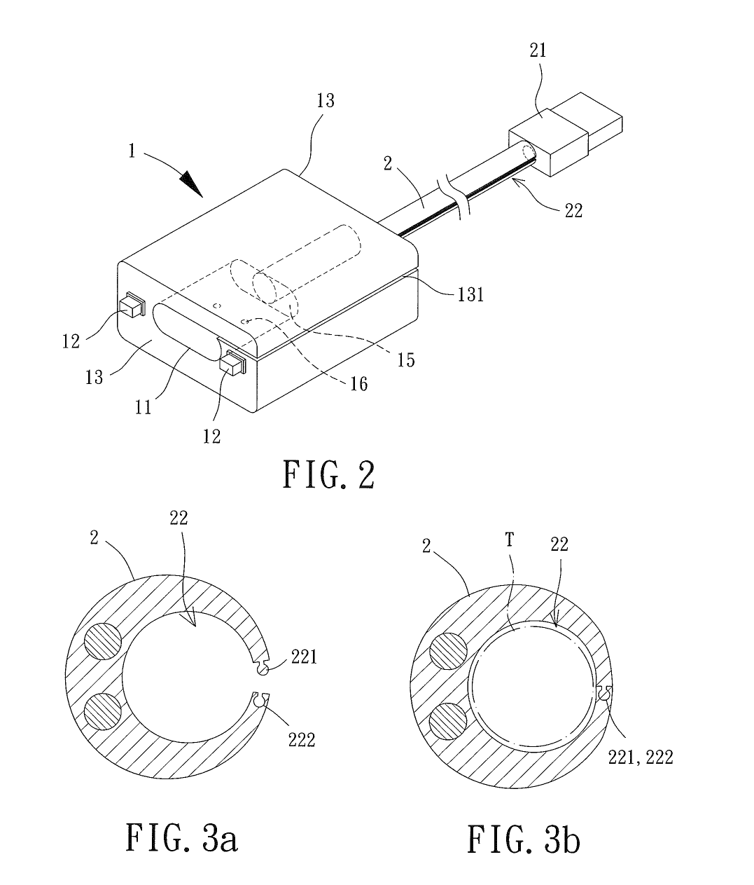

Please refer to FIG. 2, an electrical connecting module for a jacket of a handheld electronic device according to a second embodiment of the present invention is shown. In FIG. 2, the fixing portion 22 includes an opening facing in the width direction. The fixing portion 22 may form a fastener as shown in FIGS. 3a and 3b, with a tongue 221 and a groove 222 respectively arranged at two ends of the fixing portion 22. The tongue 221 and the groove 222 may be engaged with each other after the transmission line T is fixed in the fixing portion 22. As shown in FIG. 2, a breaking portion 131 is formed on one of the two lateral surfaces and extends from the front surface 13 to the rear surface 13. The breaking portion 131 also extends from the one of the lateral surfaces to an inner periphery of the body 1 defining the retaining hole 11. Therefore, a user can lift open the breaking portion 131 and position the connecting plug T1 inside the retaining hole 11 through the one of the two lateral surfaces before closing the breaking portion. However, the implementation is not taken as a limited sense.

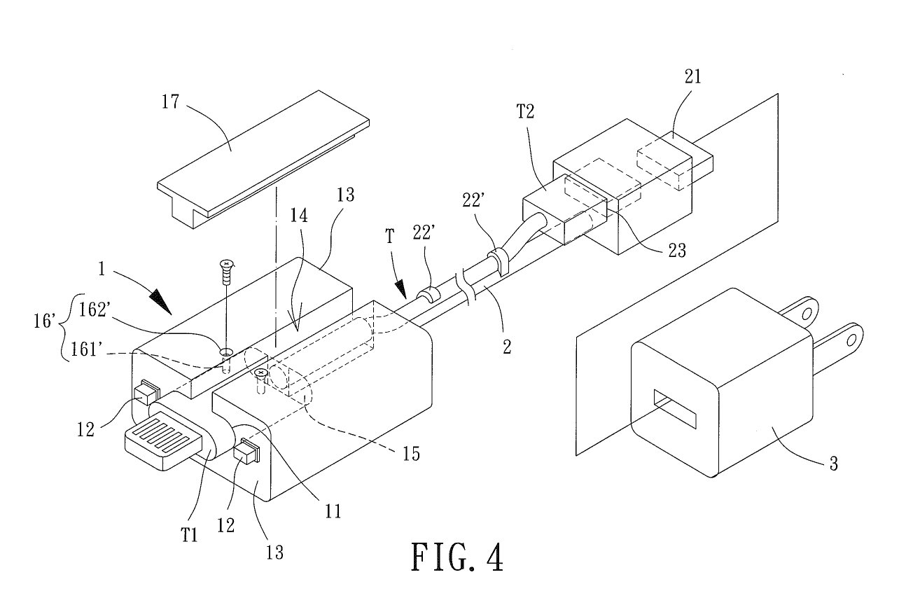

Please refer to FIG. 4, an electrical connecting module for a jacket of a handheld electronic device according to a third embodiment is shown. In FIG. 4, a receiving channel 14 is formed on the top surface of the body 1 and extends from the front surface 13 to the rear surface 13. The receiving channel 14 also extends from the top surface to the inner periphery of the body 1 defining the retaining hole 11. Therefore, a user can insert the connecting plug T1 into the retaining hole 11 through the receiving channel 14. In addition, the body 1 may further include a dust cover 17 to be received in the receiving channel 14. Thus, the receiving channel 14 is closed by the dust cover 17 to prevent the accumulation of dust. Another fixing portion 22′ may be arranged on the outer surface of the conducting wire 2. The fixing portion 22′ may be in the form of at least one hook. In the case that more than one hook are used, the hooks can be arranged in opposite directions to provide a reinforced fixing effect.

Please refer to FIG. 4, the conducting wire 2 may include a first connecting port 23, such as a USB socket for insertion of the USB plug T2 of the transmission line “T.” The first connecting port 23 may be arranged adjacent to and electrically connected with the connector 21. Thus, the connector 21 and the USB plug T2 are supplied by the same power source. Furthermore, the connector 21 may be plugged into an adapter, such as an AC/DC converter for receiving DC power.

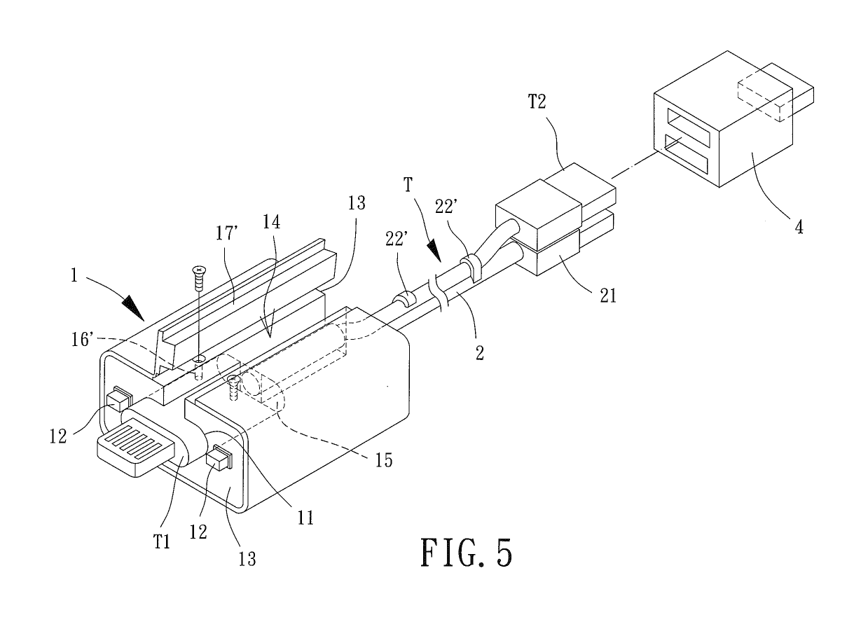

Please refer to FIG. 5, an electrical connecting module for a jacket of a handheld electronic device according to a fourth embodiment of the present invention is shown. In FIG. 5, the USB plug T2 and the connector 21 are plugged into a splitter 4 to receive the power, such as a USB adapter or a USB converter that includes one plug and two sockets.

In this embodiment, the body 1 may include a dust cover 17′ to prevent accumulation of dust in the receiving channel 14. The dust cover 17′ has one end that is connected with the body 1 in a bendable manner, so that the dust cover can be bent in order to be received in or disengaged from the receiving channel 14.

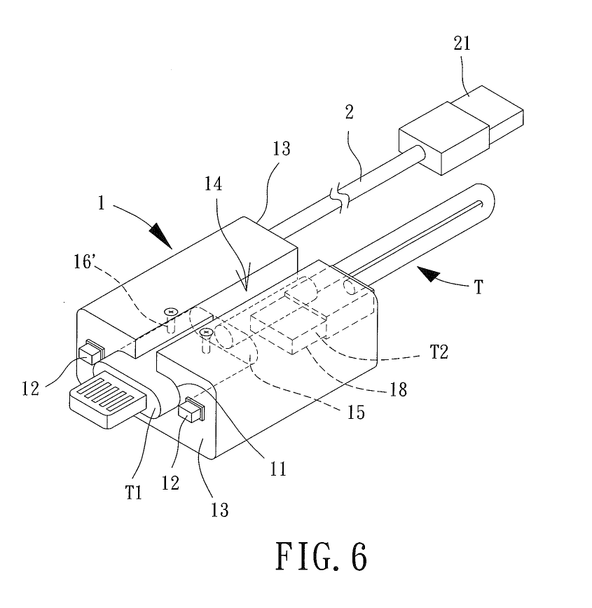

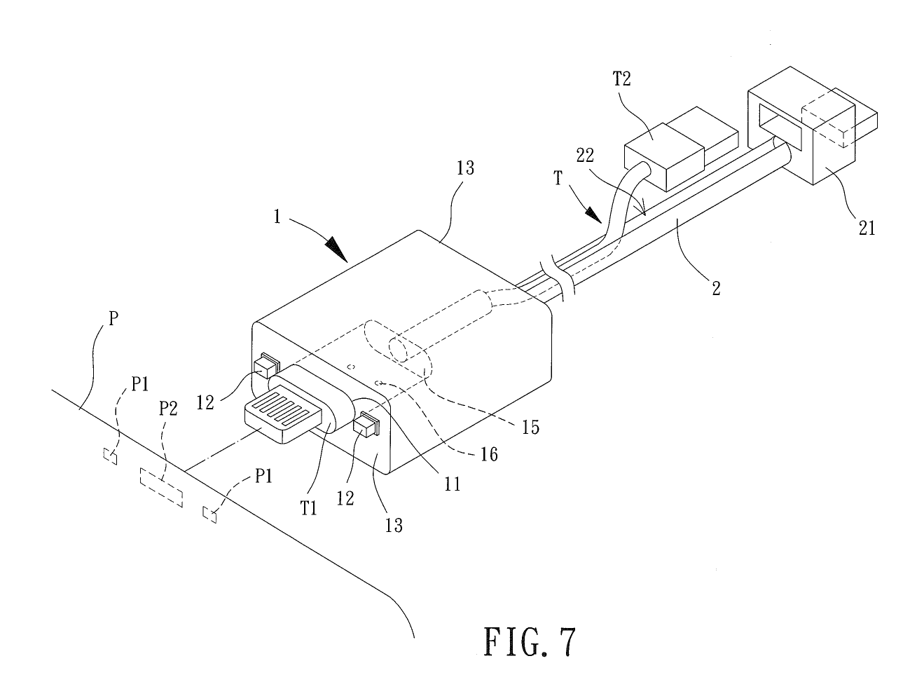

Please refer to FIG. 6, an electrical connecting module for a jacket of a handheld electronic device according to a fifth embodiment of the present invention is shown. In FIG. 6, the body 1 further includes a second connecting port 18 for insertion of the USB plug T2 of the transmission line “T,” and the second connecting port 18 is electrically connected to the conducting wire 2. Therefore, the conducting wire 2 can deliver power to the connecting plug T1 of the transmission line “T” and the plurality of electrical contacts 12 of the body 1 at the same time. In this regard, a user can plug the USB plug T2 of the transmission line “T” into the second connecting port 18 of the body 1 to power the handheld electronic device and the jacket at the same time.

Please refer to FIGS. 1, 2, 4 and 6, a positioning portion 15 (such as a shoulder) may be formed on the inner periphery of the body 1, and is adapted to abut with the connecting plug T1 of the transmission line “T” so as to securely fix the connecting plug T1 in the retaining hole 11 (as shown in FIG. 4). To provide a reinforced engagement between the transmission line “T” and the body 1, the connecting plug T1 may be fixed in the retaining hole 11 in a press fit manner, and a covering material, such as a thermoplastic sleeve, a resin sleeve, a silicone sleeve or a shell, is used to envelop the body 1 and the transmission line “T” altogether. Alternatively, at least one through-hole 16 may be arranged on the top surface of the body 1 and communicates with the retaining hole 11 as shown in FIGS. 1 and 2. The through-hole 16 may be filled with gel to adhere the body 1 and the connecting plug T1 to each other. As shown in FIGS. 4-6, the through-hole 16′ may be in the form of a countersink, and may be arranged on the top surface of the body 1 and communicates with the retaining hole 11. The through-hole 16′ may include a screwed portion 161′ and a head portion 162′ to be screwed by a screw for engagement of the body 1 and the connecting plug T1. However, the implementation is not taken as a limited sense.

Please refer to FIG. 7, which shows the use of the electrical connecting module in combination with the transmission line “T” according to the first embodiment of the present invention. Assume the jacket “P” has a built-in fan as well as a plurality of electrical ports P1 and a transmission port P2 arranged on the outer face thereof. In this regard, when the jacket “P” is to be supplied with power, the body 1 may be connected to the jacket “P,” such that the plurality of electrical contacts 12 is in contact with the plurality of electrical ports P1. Then, a power source (such as a 5V DC power source) is electrically connected to the connector 21 to deliver the electrical power to the jacket “P” via the electrical port P1, thus driving the fan of the jacket “P” to rotate. Meanwhile, the connecting plug T1 of the transmission line “T” can be received in the retaining hole 11 of the body 1 to allow the connecting plug T1 to be connected to the transmission port P2 of the jacket “P” for charging purposes or data transmission purposes of the handheld electronic device.

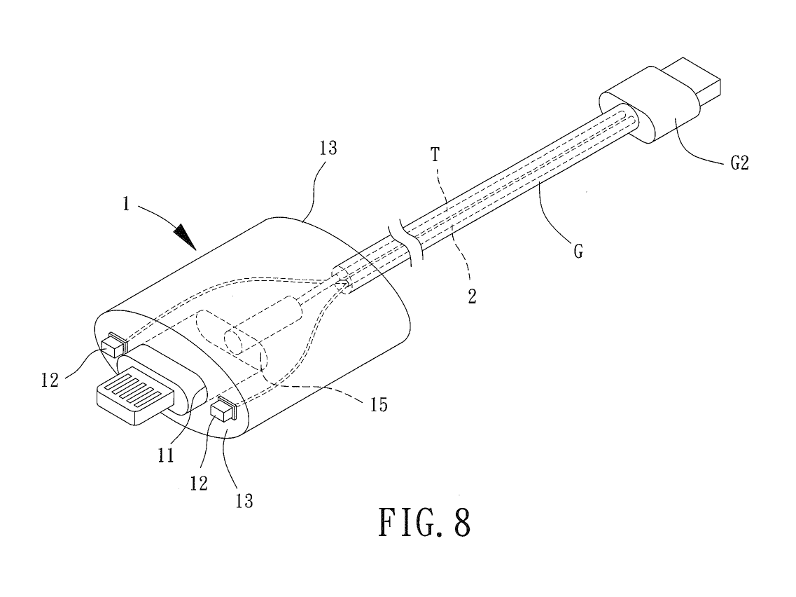

Please refer to FIG. 8, an electrical connecting assembly according to a sixth embodiment of the present invention consists of the electrical connecting module and the transmission line as previously described. In this embodiment, the conducting wire 2 of the electrical connecting module and the transmission line “T” are combined as a conducting cable “G” The conducting cable “G” is made by wrapping the conducting wire 2 and the transmission line “T” with a covering material in an injection molding manner or by melting a plastic material. Alternatively, the conducting cable “G” may be formed by wrapping the conducting wire 2 and the transmission line “T” with a fastener as described previously or with a thermoplastic sheath. One end of the conducting cable “G” is connected to the body 1, and the other end of the conducting cable “G” forms an electrical plug G2. The electrical plug G2 is electrically connected to the conducting wire 2 and the transmission line in order to supply power to the handheld electronic device and the jacket at the same time.

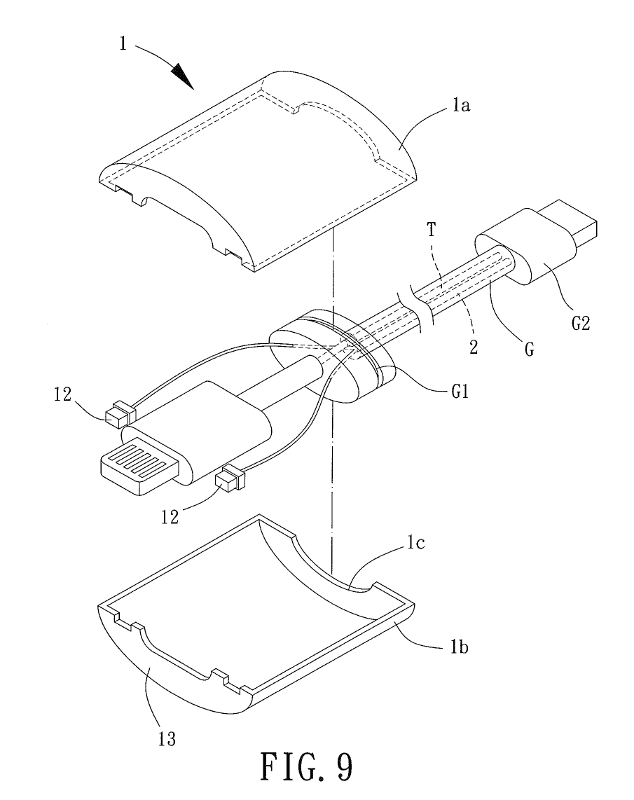

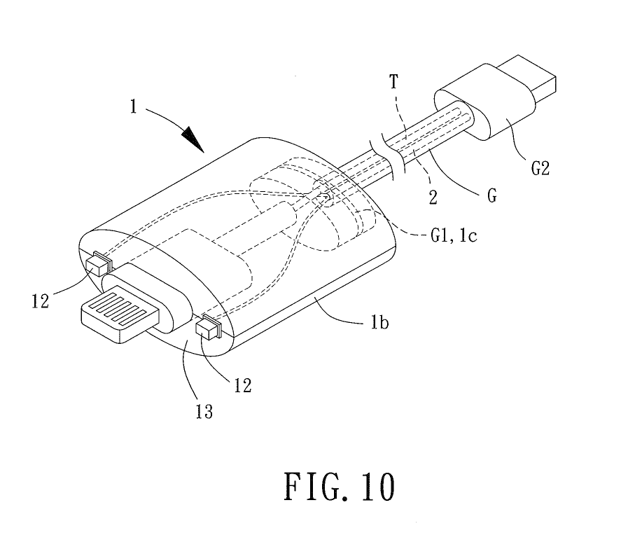

Please refer to FIGS. 9 and 10, an electrical connecting assembly according to a seventh embodiment of the present invention is shown. In FIG. 9, the body 1 may include a first case 1a and a second case 1b coupled to the first case 1a. An arcuate edge is formed on an end face of the first case 1a, and another arcuate edge is formed on an end face of the second case 1b. The first and second cases 1a and 1b jointly form a first engaging portion 1c defined by the arcuate edges of the first and second cases 1a and 1b, and the conducting cable “G” includes a second engaging portion G1 (such as a groove formed on an outer periphery thereof). The first engaging portion 1c is engaged with the second engaging portion G1 in a manner that the arcuate edges of the first engaging portion 1c are engaged in the groove of the second engaging portion G1 in order to fix the conducting cable “G” and the body 1 to each other and to prevent breaking of the conducting wire 2 and the transmission line “T” resulting from frequent pulling of said wire 2 and line “T.” However, the structure of the electrical connecting assembly described above is not taken as a limited sense.

As a conclusion, the electrical connecting module for the jacket of the handheld device and the electrical connecting assembly of the present invention are characterized as follows. The body includes the retaining hole and the plurality of electrical contacts. The connecting plug is partially received in the retaining hole of the body so that the connecting plug of the transmission line and the plurality of electrical contacts are located at the same end of the body. The conducting wire is electrically connected with the plurality of electrical contacts. As such, a power source may be electrically connected to the plurality of electrical contacts via the conducting wire to supply power to an electronic element in the jacket such as the fan. Meanwhile, the charging operation and data transmission of the handheld electronic device can be performed via the transmission line. Therefore, power can be supplied to the jacked while data transmission or charging operation of the electronic device can be performed using a single electrical connecting assembly (such as the electrical connecting assembly or the electrical connecting module in combination with the transmission line). Advantageously, the jacket can still be powered without affecting the original charging and data transmission functions of the handheld device. Furthermore, it is not needed to use multiple cables, thereby providing a better user experience of the handheld electronic device.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. An electrical connecting module for a jacket of a handheld electronic device comprising:
a body comprising a retaining hole and a plurality of electrical contacts, wherein the retaining hole is adapted to partially receive a connecting plug of a transmission line, and wherein the plurality of electrical contacts is located at an end of the body; and
a conducting wire electrically connected to the plurality of electrical contacts.

2. The electrical connecting module for the jacket of the handheld electronic device as claimed in claim 1, wherein the connecting plug and the plurality of electrical contacts are located at the end of the body when the connecting plug is partially received in the retaining hole.

3. The electrical connecting module for the jacket of the handheld electronic device as claimed in claim 1, wherein the plurality of electrical contacts is located at two opposite sides of the retaining hole.

4. The electrical connecting module for the jacket of the handheld electronic device as claimed in claim 1, wherein the body further comprises two opposite end faces, and the retaining hole extends through the two end faces.

5. The electrical connecting module for the jacket of the handheld electronic device as claimed in claim 4, wherein the body further comprises a lateral surface arranged between the two end faces, wherein a breaking portion is formed on the lateral surface and extends through the two end faces, and wherein the breaking portion further extends from the lateral surface to an inner periphery of the body defining the retaining hole.

6. The electrical connecting module for the jacket of the handheld electronic device as claimed in claim 4, wherein the body further comprises a top surface arranged between the two end faces, wherein a receiving channel is formed on the top surface and extends through the two end faces, and wherein the receiving channel further extends from the top surface to an inner periphery of the body defining the retaining hole.

7. The electrical connecting module for the jacket of the handheld electronic device as claimed in claim 6, wherein the body further comprises a dust cover adapted to close the receiving channel.

8. The electrical connecting module for the jacket of the handheld electronic device as claimed in claim 7, wherein the dust cover has one end that is connected to the body in a bendable manner.

9. The electrical connecting module for the jacket of the handheld electronic device as claimed in claim 4, wherein the body further comprises a top surface arranged between the two end faces, wherein a through-hole is formed on the top surface and communicates with the retaining hole.

10. The electrical connecting module for the jacket of the handheld electronic device as claimed in claim 9, wherein the through-hole is filled with gel to adhere the body and the connecting plug to each other.

11. The electrical connecting module for the jacket of the handheld electronic device as claimed in claim 9, wherein the through-hole is in a form of a countersink adapted to be screwed by a screw in order for the body and the connecting plug to be engaged to each other.

12. The electrical connecting module for the jacket of the handheld electronic device as claimed in claim 1, wherein the body and the connecting plug are enveloped together by a covering material.

13. The electrical connecting module for the jacket of the handheld electronic device as claimed in claim 12, wherein the covering material is a thermoplastic sleeve, a resin sleeve or a silicone sleeve.

14. The electrical connecting module for the jacket of the handheld electronic device as claimed in claim 12, wherein the covering material is a shell.

15. The electrical connecting module for the jacket of the handheld electronic device as claimed in claim 1, wherein the connecting plug is fixed in the retaining hole of the body in a press fit manner.

16. The electrical connecting module for the jacket of the handheld electronic device as claimed in claim 1, wherein a positioning portion is formed on an inner periphery of the body defining the retaining hole.

17. The electrical connecting module for the jacket of the handheld electronic device as claimed in claim 16, wherein the positioning portion is a shoulder.

18. The electrical connecting module for the jacket of the handheld electronic device as claimed in claim 1, wherein the body further comprises a connecting port electrically connected to the conducting wire.

19. The electrical connecting module for the jacket of the handheld electronic device as claimed in claim 1, wherein a fixing portion is arranged on an outer surface of the conducting wire.

20. The electrical connecting module for the jacket of the handheld electronic device as claimed in claim 19, wherein the fixing portion is a groove.

21. The electrical connecting module for the jacket of the handheld electronic device as claimed in claim 19, wherein the fixing portion comprises an opening facing in a width direction of the body.

22. The electrical connecting module for the jacket of the handheld electronic device as claimed in claim 19, wherein the fixing portion is a fastener having a tongue and a groove respectively arranged at two ends thereof.

23. The electrical connecting module for the jacket of the handheld electronic device as claimed in claim 19, wherein the fixing portion is in a form of at least one hook.

24. The electrical connecting module for the jacket of the handheld electronic device as claimed in claim 23, wherein the at least one hook comprises a plurality of hooks, and adjacent two of the plurality of hooks are arranged in opposite directions.

25. The electrical connecting module for the jacket of the handheld electronic device as claimed in claim 1, wherein the conducting wire comprises one end connected to the body and another end connected with a connector.

26. The electrical connecting module for the jacket of the handheld electronic device as claimed in claim 25, wherein the connector is a USB connector.

27. The electrical connecting module for the jacket of the handheld electronic device as claimed in claim 25, wherein the conducting wire comprises a conducting port adjacent and electrically connected to the connector.

28. The electrical connecting module for the jacket of the handheld electronic device as claimed in claim 27, wherein the connector is electrically connected to a converter.

29. The electrical connecting module for the jacket of the handheld electronic device as claimed in claim 25, wherein the transmission line comprises a USB plug, and wherein the USB plug and the connector are electrically connected to a splitter.

30. An electrical connecting assembly comprising:
a transmission line comprising a connecting plug; and
an electrical connecting module comprising a body and a conducing wire, wherein the body comprising a retaining hole and a plurality of electrical contacts, wherein the connecting plug is partially received in the retaining hole, wherein the plurality of electrical contacts is located at an end of the body and electrically connected to the conducting wire, and wherein the conducting wire and the transmission line are combined as a conducting cable.

31. The electrical connecting assembly as claimed in claim 30, wherein the conducting wire and the transmission line are integrally formed as the conducting cable.

32. The electrical connecting assembly as claimed in claim 30, wherein the conducting cable is made by wrapping the conducting wire and the transmission line with a covering material.

33. The electrical connecting assembly as claimed in claim 30, wherein the connecting plug and the plurality of electrical contacts are located at the end of the body when the connecting plug is partially received in the retaining hole.

34. The electrical connecting assembly as claimed in claim 30, wherein the plurality of electrical contacts is located at two opposite sides of the retaining hole.

35. The electrical connecting assembly as claimed in claim 30, wherein the body further comprises two end faces, and wherein the retaining hole extends through the two end faces.

36. The electrical connecting assembly as claimed in claim 30, wherein the connecting plug is fixed in the retaining hole in a press fit manner.

37. The electrical connecting assembly as claimed in claim 30, wherein a positioning portion is formed on an inner periphery of the body defining the retaining hole and is adapted to abut with the connecting plug.

38. The electrical connecting assembly as claimed in claim 37, wherein the positioning portion is a shoulder.

39. The electrical connecting assembly as claimed in claim 30, wherein the conducting cable comprises one end connected to the body and another end forming an electrical plug, and wherein the electrical plug is electrically connected to the conducting wire and the transmission line.

40. The electrical connecting assembly as claimed in claim 30, wherein the body comprises a first case and a second case.

41. The electrical connecting assembly as claimed in claim 40, wherein a first engaging portion is formed on an end face of the body, wherein a second engaging portion is formed on the conducting cable and is adapted to be engaged with the first engaging portion.

42. The electrical connecting assembly as claimed in claim 41, wherein the first engaging portion is an arcuate edge defining an opening, and the second engaging portion is a groove adapted to be engaged with the arcuate edge of the opening.
